(19) United States
(12) Patent Application Publication
(10) Pub. No.: US 2026/0349564 A1
(43) Pub. Date: Nov. 5, 2026

(54) QUICK EVENT REPORTING FROM TOUCH SENSOR TO DISPLAY PANEL TO BOOST FRAME RATE

(71) Applicant: QUALCOMM Incorporated, San Diego, CA (US)

(72) Inventors: Nan Zhang, Beijing (CN); Long HAN, Shanghai (CN)

(21) Appl. No.: 19/478,232

(22) PCT Filed: May 22, 2023
(86) PCT No.: PCT/CN2023/095478

§ 371 Date: Oct. 23, 2025

(51) Int. Cl. G06F 3/041; G06F 1/3218; G06F 1/3234; G09G 5/00

(52) U.S. Cl. CPC G06F 3/0418; G06F 1/3218; G06F 1/3265; G09G 5/006; G09G 2330/023; G09G 2340/0435; G09G 2354/00

(57) ABSTRACT

This disclosure provides methods, devices and systems for display processing. Associated processes may include receiving an indication of a potential touch event at a touch sensor circuit and notifying a display panel circuit of the potential touch event via a signal communicated from the touch sensor circuit to the display panel circuit. An illustrative process may further include changing a frame rate at the display panel circuit from a first frame rate to a second frame rate in response to the indication. In some aspects, the processes may further include switching back the frame rate from the second to the first frame rate in response to the potential touch event being determined to be a false event. Alternatively, the processes may include maintaining the frame rate at the second frame rate in response to the potential touch event being determined to be valid.

### TECHNICAL FIELD

The present disclosure relates generally to digital processing systems, and more particularly, to one or more techniques associated with digital display and graphics processing.

### DESCRIPTION OF THE RELATED TECHNOLOGY

Computing devices often use a graphics processing unit (GPU) to accelerate the rendering of graphical data for display. Such computing devices may include, for example, computer workstations, smartphones, embedded systems, personal computers, tablet computers, and video game consoles. GPUs execute a graphics processing pipeline that includes one or more processing stages. The processing stages operate together to execute graphics processing commands and to output a frame to a display panel.

The GPU provides consecutive digital frames of video content to a display panel. The still frames are played in quick succession to present animation or video for a game, among other applications. The frequency at which the frames are presented, or the frame rate, may impact playback performance. For example, a high frame rate may enable the realistic playback of video content featuring motion, while the same playback accompanied with a slower frame rate may appear choppy and slow.

To conserve processing power, the display panel may operate using a relatively low frame rate when visual content is not updating. For instance, an idling frame rate may be under one hertz, or one frame per second (FPS). The frame rate is ideally boosted to meet display panel frame requirements when video content is updated. In one example, such content updating occurs during a refresh operation in response to a user touching their smartphone display. The touch generates corresponding touch sensor event data.

Boosting to a high frame rate from idle conventionally involves routing the touch sensor event data through the hardware stages and software stacks of the graphics processing pipeline. The time required to route the touch sensor event data through the graphics processing pipeline may result in a boosting delay at the display panel. The boosting delay may result in perceptible content glitches and interruptions that detract from a viewing experience.

### SUMMARY

The systems, methods, and devices of this disclosure each have several innovative aspects, no single one of which is solely responsible for the desirable attributes disclosed herein.

One innovative aspect of the subject matter described in this disclosure may be implemented as a method of display processing, the method comprising receiving an indication of a potential touch event at a touch sensor circuit and notifying a display panel circuit of the potential touch event via a signal communicated from the touch sensor circuit to the display panel circuit. The method may further include changing a frame rate at the display panel circuit from a first frame rate to a second frame rate in response to the indication.

In some aspects, the method may further include switching back the frame rate from the second to the first frame rate in response to the potential touch event being determined to be a false event. Alternatively, the method may include maintaining the frame rate at the second frame rate in response to the potential touch event being determined to be valid.

In some implementations, the method may further include communicating the signal via a hardware pin connecting the sensor circuit to the display panel circuit.

Processes may request the first frame rate from a host processor in response to the notifying. The method may include configuring the first frame rate of display to be faster than the second frame rate of display.

In some aspects, the method may further include determining a false event at a host processor. Processes may include filtering for a false event at a host processor.

In certain implementations, the method may further include monitoring for the touch event at the display panel circuit. In another or the same implementation, the method may include communicating raw touch data to a host processor in response to the potential touch event.

According to one implementation, the method may include determining a false event in response to a timeout function based on a time the raw touch data was communicated. Processes may determine a false event at a sensor hub module and communicating the determination to an operating system input service module in another or the same implementation, the method may include processing the raw touch data at the host processor.

Another innovative aspect of the subject matter described in this disclosure may be implemented in an apparatus that includes a touch sensor circuit to sense user physical contact comprising a touch event, and a display panel circuit to render graphical data for display. The memory may also include a memory and one or more processors communicatively coupled with the memory, the display panel circuit, and the touch sensor circuit, the one or more processors configured to receive an indication of a potential touch event at the touch sensor circuit, notify the display panel circuit of the potential touch event via a signal communicated from the touch sensor circuit to the display panel circuit, and change a frame rate at the display panel circuit from a first frame rate to a second frame rate in response to the indication.

In some aspects, the frame rate is switched from the second to the first frame rate in response to the potential touch event being determined to be a false event. Alternatively, the frame rate is maintained at the second frame rate in response to the potential touch event being determined to be valid.

In another aspect, a hardware pin connects the sensor circuit to the display panel circuit, wherein the hardware pin communicates the signal. The apparatus may further include a host device configured to execute the one or more processors to receive a request for the first frame rate. The host device may be configured to execute the one or more processors to determine a false event.

According to a particular aspect, the first frame rate of display is faster than the second frame rate of display. A host device may be configured to execute the one or more processors to filter for a false event. A display panel circuit may monitor for the touch event. The host device may be configured to execute the one or more processors to receive raw touch data in response to the potential touch event.

According to another aspect, the false event is determined in response to a timeout function based on a time the raw touch data was communicated. A host device of the apparatus may be configured to execute the one or more processors to evaluate the raw touch data at the host processor.

Another innovative aspect of the subject matter described in this disclosure may be implemented in a graphics processing device that includes a means for receiving an indication of a potential touch event at a touch sensor circuit, a means for notifying a display panel circuit of the potential touch event via a signal communicated from the touch sensor circuit to the display panel circuit, and a means for changing a frame rate at the display panel circuit from a first frame rate to a second frame rate in response to the indication.

According to a particular aspect, the graphics processing device may include a means for switching back the frame rate from the second to the first frame rate in response to the potential touch event being determined to be a false event. The graphics processing device may additionally or alternatively include a means for communicating the signal via a hardware pin connecting the sensor circuit to the display panel circuit.

Another innovative aspect of the subject matter described in this disclosure may be implemented in a non-transitive computer-readable medium storing computer executable code for graphics processing, the computer executable code being configured to receive an indication of a potential touch event at a touch sensor circuit, notify a display panel circuit of the potential touch event via a signal communicated from the touch sensor circuit to the display panel circuit, and change a frame rate at the display panel circuit from a first frame rate to a second frame rate in response to the indication.

### BRIEF DESCRIPTION OF THE DRAWINGS

Details of one or more implementations of the subject matter described in this disclosure are set forth in the accompanying drawings and the description below.

Other features, aspects, and advantages will become apparent from the description, the drawings and the claims. Note that the relative dimensions of the following figures may not be drawn to scale.

FIG. 1 is a block diagram that illustrates an example content generation system in accordance with one or more techniques of this disclosure.

FIG. 2 is a block diagram of a system that includes a processing unit, a display processor, a touch panel, and a display client.

FIG. 3 is a block diagram of an embodiment of a digital signal processor (DSP) graphics display system that includes hardware and software modules for preemptively boosting the FPS at a panel display circuit as touch sensor event data is concurrently evaluated for accuracy in the processes stages of a host circuit.

FIG. 4 is a graph that plots a frame rate (e.g., measured in FPS) supplied to a display module versus touch event timing information when touch event data is sent only to the host processing unit to be processed through the hardware stages and software stacks of the graphics processing pipeline.

FIG. 5 is a graph that plots a frame rate (e.g., measured in FPS) supplied to a display screen versus touch event timing information in a scenario where the frame rate supplied to the display screen may be communicated directly from a touch sensor (e.g., in addition to the host device).

FIG. 6 is a graph that plots a frame rate (e.g., measured in FPS) supplied to a display screen versus touch event timing information in a scenario where the touch event is eventually determined to be a false alarm.

FIG. 7 is a flowchart of an embodiment of a method of managing frame rates when displaying video data to a user.

FIG. 8 is an illustrative implementation of a method of display processing.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein may be applied in a multitude of different ways. In a particular implementation, touch event information is communicated directly from a touch sensor to a display panel module. In so doing, the system may make a higher frame rate immediately available to a display panel pending thorough analysis at the host. Put another way, the system may front, prospect, or advance the higher frame rate in response to a direct signal from a touch sensor that indicates a potential touch event.

Particular aspects of the subject matter described in this disclosure may be implemented to realize one or more of the following potential advantages. For example, touch event information communicated directly from the touch panel to the display client over a pin may make a higher frame rate immediately available to the display client prior to thorough analysis at the processing unit. By making the higher frame rate immediately available, the viewing experience of the user is not marred by pausing and glitches associated with convention boost delays. Where the filtered signal confirms that the touch event data is legitimate (i.e., not a false alarm), then the high frame rate that was preemptively provided may be maintained. That is, the high frame rate will not be switched back to idle or some slower frame rate. Where the filtered signal otherwise indicates that the potential touch event was a false alarm, then the high frame rate may be lowered back to the idle state to conserve processing resources.

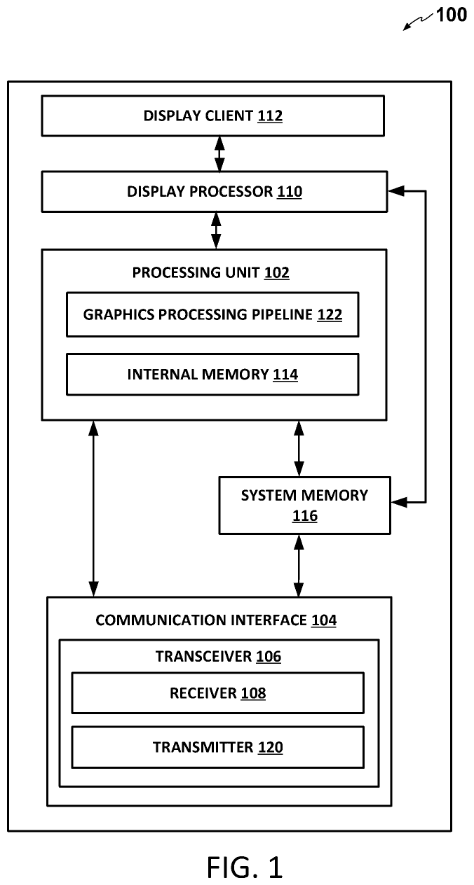

FIG. 1 is a block diagram that illustrates an example content generation system 100 configured to implement one or more techniques of this disclosure. The content generation system 100 may include one or more components or circuits for performing various functions described herein. In some examples, the one or more components of the content generation system 100 may be modules of a system on a chip (SOC). The content generation system 100 may include one or more components configured to perform one or more techniques of this disclosure. In the example shown, the content generation system 100 may include a processing unit 102 and a system memory 116. In the particular example of FIG. 1, the content generation system 100 includes a number of optional components: a communication interface 104, a transceiver 106, a receiver 108, and a transmitter 120, as well as a display processor 110 and a display client 112.

Reference to the display client 112 may refer to one or more displays. For example, the display client 112 may include a single display or multiple displays. The display client 112 may include a first display and a second display. In other examples, the results of the graphics processing may not be displayed on the device, e.g., the first and second displays may not receive any frames for presentment thereon. Instead, the frames or graphics processing results may be transferred to another device. In some aspects, this transference may be referred to as split-rendering.

The processing unit 102 may include an internal memory 114 and may be configured to perform graphics processing, such as are associated with a graphics processing pipeline 122. In some examples, the display processor 110 of the system 100 may perform one or more display processing techniques on one or more frames generated by the processing unit 102 before presentation by the display client 112.

The illustrative display processor 110 of FIG. 1 may be configured to perform display processing. For example, the display processor 110 may be configured to perform one or more display processing techniques on one or more frames generated by the processing unit 102. The display client 112 may be configured to display or otherwise present frames processed by the display processor 110. In some examples, the display client 112 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 102, such as system memory 116, may be accessible to the processing unit 102. In another or the same example, the processing unit 102 may be configured to read from and/or write to external memory, such as the system memory 116. The processing unit 102 may be communicatively coupled to the system memory 116 over a bus. In some examples, the processing unit 102 and the system memory 116 may be communicatively coupled to each other over the bus or a different connection.

It should be appreciated that in some examples, the content generation system 100 may include a content encoder/decoder configured to receive graphical and/or display content from any source, such as the system memory 116 and/or the communication interface 104. The system memory 116 may be configured to store received encoded or decoded graphical content. In some examples, the content encoder/decoder may be configured to receive encoded or decoded graphical content (e.g., from the system memory 116 and/or the communication interface 104) in the form of encoded pixel data. In some examples, the content encoder/decoder may be configured to encode or decode various types of graphical content.

The internal memory 114 or the system memory 116 may include one or more volatile or non-volatile memories or storage devices. In some examples, internal memory 114 or the system memory 116 may include random-access memory (RAM), static random-access memory (SRAM), dynamic random-access memory (DRAM), erasable programmable read-only memory (EPROM), electrically erasable programmable read-only memory (EEPROM), flash memory, a magnetic data media, an optical storage media, or any other type of memory.

The internal memory 114 or the system memory 116 may be a non-transitory storage medium according to some examples. The term “non-transitory” may indicate that the storage medium is not embodied in a carrier wave or a propagated signal. However, the term “non-transitory” should not be interpreted to mean that internal memory 114 or the system memory 116 is non-movable or that its contents are static. As one example, the system memory 116 may be removed from the content generation system 100 and moved to another device. As another example, the system memory 116 may not be removable from the content generation system 100.

The processing unit 102 may be a central processing unit (CPU), a graphics processing unit (GPU), a general-purpose GPU (GPGPU), or any other processing unit that is configured to perform graphics processing. In some examples, the processing unit 102 may be integrated into a motherboard of the content generation system 100. In some examples, the processing unit 102 may be present on a graphics card that is installed in a port in a motherboard of the content generation system 100. In another example, the processing unit 102 may be incorporated within a peripheral device configured to interoperate with the content generation system 100.

The processing unit 102 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If associated techniques are implemented partially in software, the processing unit 102 may store instructions for the software in a suitable, non-transitory computer-readable storage medium, e.g., internal memory 114, and may execute the instructions in hardware using one or more processors to perform the techniques of this disclosure. Any of the foregoing, including hardware, software, a combination of hardware and software, etc., may be considered to be one or more processors.

In the implementation of FIG. 1, the content generation system 100 includes a communication interface 104. The communication interface 104 may include a receiver 108 and a transmitter 120. The receiver 108 may be configured to perform receiving functions described herein with respect to the content generation system 100. Additionally, the receiver 108 may be configured to receive information, e.g., eye or head position information, rendering commands, or location information, from another device.

The transmitter 120 may be configured to perform any transmitting function described herein with respect to the content generation system 100. For example, the transmitter 120 may be configured to transmit information to another device, which may include a request for content. The receiver 108 and the transmitter 120 may be combined into a transceiver 106. In such examples, the transceiver 106 may be configured to perform receiving and/or transmitting functions described herein with respect to the content generation system 100.

In some examples, the graphical content from the processing unit 102 for display via the display client 112 is not static and may be changing. Accordingly, the display processor 110 may periodically refresh the graphical content displayed via the display client 112. For example, the display processor 110 may periodically retrieve graphical content from the system memory 116. The graphical content may have been updated at the system memory 116 by the execution of an application (and/or the processing unit 102) that outputs the graphical content to the system memory 116.

The rate at which the display processor 110 refreshes the graphical content displayed via the display client 112 may be referred to as the frames per second (FPS) rate, or the “display refresh rate.” Examples of the display refresh rate include 30 fps, 60 fps, 90 fps, 102 fps, 240 fps, etc.

There may be various factors that affect the display refresh rate. For example, if the processing unit 102 is executing a video game application, then the processing unit 102 (and/or the GPU) may be generating graphical content (e.g., a computer-generated animation) at a relatively high rate. For smooth playback of the animations, the display processor 110 may attempt to refresh the graphical content displayed via the display client 112 at a relatively high display refresh rate (e.g., 90 fps).

In some examples, if the display refresh rate is too slow, then the graphical content displayed may appear laggy or jumpy (also referred to as “jank”). For example, if the display refresh rate is slower than the change in frames of the animation, then the animation may appear laggy or jumpy. It should be appreciated that in some examples, the display refresh rate of the display client may be relatively slow because the display client is operating in an idle state. For example, the display client may switch to an idle state to conserve power (e.g., while there is no user interaction).

In some examples, an application that generated the graphical content that a display processor is accessing may be configured to determine a display refresh rate. In a particular instance, a display hardware abstraction layer (HAL) application may be configured to determine the display refresh rate. The display HAL application may include an application that enables applications that generate graphical content to communicate with a display driver. As disclosed herein, there may conventionally be a delay associated with the application or the display HAL application determining that there was a touch event, determining that the display refresh rate is to be changed, and then instructing the display drive to change the display refresh rate.

As further disclosed herein, an implementation includes the display driver directly receiving a touch event signal (e.g., via a general-purpose input/output signal). The display driver may thus more quickly determine a change to the display refresh rate. That is, the display driver may not have to wait for the application to provide the display refresh rate and/or the display HAL application to provide the display refresh rate in order to reduce the jank caused by the low display refresh rate.

As described herein, a device, such as the content generation system 100, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

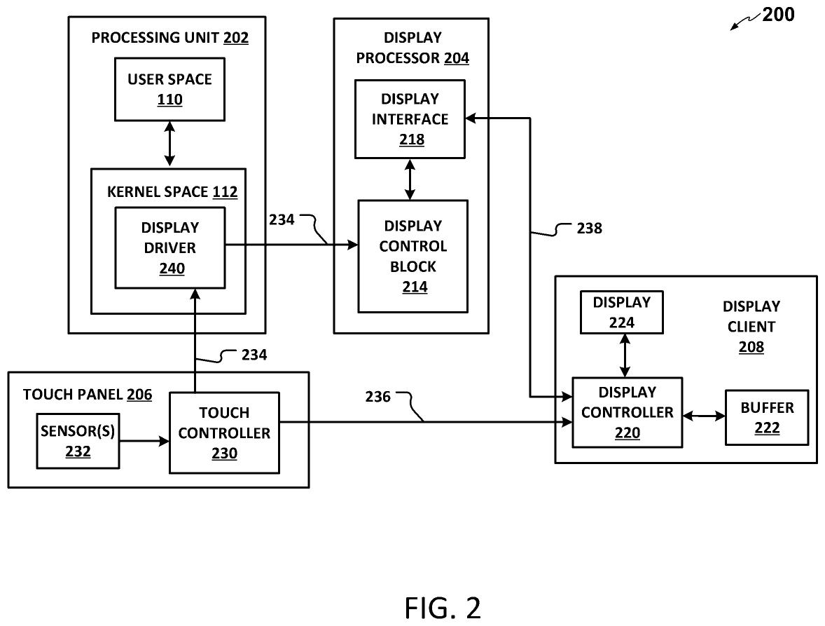

FIG. 2 is a block diagram of a system 200 that includes a processing unit 202, a display processor 204, a touch panel 206, and a display client 208. In one example, FIG. 2 illustrates in greater detail the example processing unit 102 and the example display processor 110 of FIG. 1, as well as the example display client 112 of FIG. 1.

In the illustrated example of FIG. 2, the processing unit 202 includes a user space 210 and a kernel space 212. The example kernel space 212 of FIG. 2 includes a display driver 214. The example display processor 204 includes a display control block 216 and a display interface 218. The example display client 208 includes a display controller 220, a buffer 222, and a display 224.

The illustrative system 200 also includes a touch panel 206 that comprises a touch controller 230 and one or more sensor(s) 232. Although shown separately in FIG. 2, it should be appreciated that in some examples, the touch panel 206 may be incorporated as a part of the display client 208. In the illustrated example of FIG. 2, the sensor(s) 232 may be configured to sense interactions between the user and the touch panel 206 (e.g., via the display client 208).

As the user interacts with the display client 208, the sensor(s) 232 output signals to the touch controller 230 that indicate which sensor(s) were activated, how long a sensor was activated, and a pressure associated with the sensor activation, among other measurements. The example touch controller 230 may use the sensor output signals to determine that the user interacted with the touch panel 206/display client 208. The touch controller 230 may then output a signal indicating the touch event. In an example, the touch controller 230 signals the touch event via a connection 234 general-purpose input/output (GPIO) pin 234. For example, a GPIO pin may be configured to transmit, via a GPIO signal, the touch event signal from the touch controller 230 to the display driver 240.

In a particular implementation, touch event information is communicated directly from the touch panel 206 to the display client 208. The communication over a pin 236 may make a higher frame rate immediately available to the display client 208 pending thorough analysis at the processing unit 202. Put another way, the system 200 may front, prospect, or advance the higher frame rate in response to the direct signal from the touch sensor 232 indicating a potential touch event.

In the illustrated example of FIG. 2, the processing unit 202 includes the user space 210 and the kernel space 212. The user space 210 (sometimes referred to as an “application space”) may include software application(s) and/or application framework(s). For example, software application(s) may include operating systems, media applications, graphical applications, office suite applications, etc. Application framework(s) may include frameworks that may be used with one or more software applications, such as libraries, services (e.g., display services, input services, etc.), application program interfaces (APIs), etc.

In the illustrated example of FIG. 2, the kernel space 212 includes the display driver 240. The display driver 240 may be configured to control the display processor 204. For example, the display driver 240 may determine one or more user input events based on user interactions with the touch panel 206. In some examples, the display driver 240 may cause the display processor 204 to change FPS rates based on, for instance, the touch event signal.

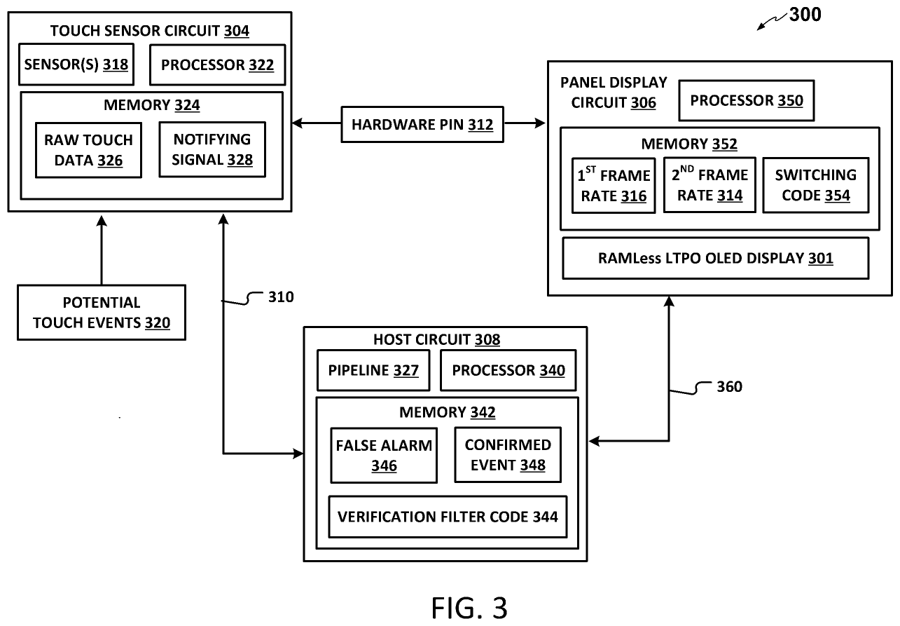

As shown in FIG. 3, the display processor 204 includes a display control block 216 and a display interface 218. The display processor 204 may be configured to operate functions of the display client 208 based on the display driver 240. For example, the display control block 216 may be configured to receive instructions from the display driver 240 to change the FPS rate of the display client 208. In some examples, the display control block 216 may additionally or alternatively perform post-processing of image data provided by the processing unit 202.

The display interface 218 may be configured to cause the display client 208 to display image frames and to display the image frames at a particular rate (e.g., a specified FPS rate). The display interface 218 may output image data to the display client 208 according to an interface protocol, such as, for example, the MIPI DSI (Mobile Industry Processor Interface, Display Serial Interface).

In the illustrated example of FIG. 2, the display client 208 includes the display controller 220, the buffer 222, and the display 224. The display controller 220 may receive image data from the display interface 218 and store the received image data in the buffer 222. In some examples, the display controller 220 may output the image data stored in the buffer 222 to the display 224. Thus, the buffer 222 may represent a local memory to the display client 208. In some examples, the display controller 220 may output the image data received from the display interface 218 to the display 224.

In an example operation, the touch panel 206 detects a touch event via the sensor(s) 232, and the touch controller 230 generates a touch event signal based on the detected touch event. The touch controller 230 may then output the touch event signal. In an example, the touch controller 230 outputs the touch event signal via a connection 234 comprising GPIO pin. Concurrently, touch event information is communicated directly from the touch panel 206 to the display client 208. The communication over the pin 236 may make a higher frame rate immediately available to the display client 208 pending more thorough analysis at the processing unit 202. In this manner, the system 200 may advance the higher frame rate in response to the direct signal from the touch sensor 232 indicating a potential touch event.

In the illustrated example, the touch event signal is provided directly from the touch controller 230 to the display driver 240. The display driver 240 may then determine to change the FPS rate of the display client 208 without having to wait for the touch event signal to pass through different drivers, user spaces, and/or services (e.g., an application and/or a display HAL application).

The display control block 216 may be configured to output image frames to the display client 208 based on the display refresh rate. The display driver 240 may output refresh rate information indicating the new display refresh rate (and/or a change in the display refresh rate). The display control block 216 may receive the refresh rate information and cause the display interface 218 to output image frames to the display client 208 based on the refresh rate information (e.g., based on a new display refresh rate and/or a change in the display refresh rate).

As disclosed herein, the display client 208 may be configured in accordance with MIPI DSI standards. The MIPI DSI standard supports a video mode and a command mode. In examples where the display client 208 is operating in video mode, the display processor 204 may continuously refresh the graphical content of the display client 208. For example, the entire graphical content may be refreshed per refresh cycle (e.g., line-by-line). In examples where the display client 208 is operating in command mode, the display processor 204 may write the graphical content of a frame to the buffer 222. In some such examples, the display processor 204 may not continuously refresh the graphical content of the display client 208. Instead, the display processor 204 may use a vertical synchronization (Vsync) pulse to coordinate rendering and consuming of graphical content at the buffer 222. For example, when a Vsync pulse is generated, the display processor 204 may output new graphical content to the buffer 222. Thus, the generating of the Vsync pulse may indicate when current graphical content at the buffer 222 has been rendered.

FIG. 3 is a block diagram of an embodiment of a digital signal processor (DSP) graphics display system 300 that includes hardware and software modules for preemptively boosting the FPS at a panel display circuit. The boost may be performed as touch sensor event data is concurrently evaluated for accuracy in the processing stages of a host circuit. In one example, the system 300 may include a random-access memory-less (RAMLess) low temperature polycrystalline oxide (LTPO) organic light-emitting diode (OLED) display panel 301.

An implementation of the system 300 may be configured to quickly switch out an idling frame rate for a higher frame rate a display panel circuit. To this end, the system 300 includes a touch sensor circuit 304, a host circuit 308, and a panel display circuit 306. The touch sensor circuit 304 is coupled to the host circuit 308 via a hardware pin 312. The hardware pin 312 may be dedicated to the purpose of enabling the touch sensor circuit 304 to provide a notifying signal 314 directly to the host circuit 308. In another implementation, the hardware pin 312 may provide additional communication signals between the touch sensor circuit 304 is coupled to the host circuit 308. In response to the notifying signal 314, the host circuit 308 may request an accelerated frame rate 314 to increase its idle speed 316.

The touch sensor circuit 308 may be configured to detect a user touching a display screen or other such tactile sensor surface. The touch sensor circuit 308 may be in communication with both the host circuit 308 and the panel display circuit 306. The touch sensor circuit 308 may concurrently communicate raw sensor data to the host circuit 308. More particularly, the touch sensor circuit 308 may send the raw touch data 326 via the hardware and software stacks of the processing stages of the graphics processing pipeline 327 of the host circuit 308. The touch sensor circuit 308 may concurrently send a signal of a potential touch event to the panel display circuit 306.

The signal may be sent in one implementation over a “quick” path comprising the hardware pin 312 connecting the touch sensor circuit 308 to the panel display circuit 306.

Turning more particularly to the components of the illustrative system 300, the sensors 318 of the touch sensor circuit 304 may receive potential touch event data 320 that has been input by user. For instance, the touch event data 320 may correspond to a user input generated by touching the screen of their mobile phone. The touch sensor circuit 304 also includes a processor 322 and a memory 324. The memory 324 of an implementation includes raw touch data 326. Also depicted in the memory 324 is the notifying signal 328 communicated to the panel display circuit 306 to initiate a boost to a higher frame rate.

The host circuit 308 of the implementation of FIG. 3 includes a processor 340 and a memory 342. The memory 342 may include verification filter code 344, in addition to false alarm data 346 and confirmed event data 348.

The panel display circuit 306 includes a display screen 301. In the illustrative system 300, the display 301 includes RAMLess LTPO OLED features. The panel display circuit 306 may also include a processor 350 and a memory 352. The memory 352 of the panel display circuit 306 includes a first frame rate 316 and a second frame rate 314. The memory 352 also includes switching code 354.

As discussed herein, the touch sensor circuit 304 of the system 300 may be in communication with the display panel driver integrated circuit 302. The touch sensor circuit 304 may be connected to the display panel driver circuit 306 via the hardware pin 312. The hardware pin 312 of one implementation is dedicated to relaying a signal from the touch sensor circuit 304. The signal may cause the display panel driver circuit 302 to request or otherwise initiate an increase, or boost, from an idle state to a high frame rate. The signal may be indicative of the touch sensor circuit 304 having detected a potential touch event.

The touch sensor circuit 304 may additionally be in communication with the host circuit 308. More particularly, the touch sensor circuit 304 may provide touch data information to the host integrated circuit 308 over a channel 310. The touch data information may comprise at least one of raw data and pre-preprocessed data. The touch data may correspond to potential touch event inputs 320 to the touch sensor circuit 304. Examples of touch data may include a user finger swiping a smartphone screen or using a stylus pen on a computing tablet. Other examples of touch data may include unintentional contact, or false events. Such false events may occur when a handheld device is accidentally bumped while in the pocket of a user, among other scenarios involving unintended physical contact.

The host circuit 308 may perform raw data processing and false alarm filtering. Raw data processing may include unfiltered potential touch inputs. False alarm filtering may include determining at the host integrated circuit 308 whether the touch sensor event data was generated in response to intentional user contact.

In one example, a timeout function executing at host integrated circuit 308 may continue to monitor further inputs from the touch sensor integrated circuit 304 for follow-up touch event data for a preset period of time. Should the host integrated circuit 308 not receive effective touch event data (e.g., processed by the touch sensor circuit 304) by the expiration of the timeout, the host integrated circuit 308 may determine the touch sensor event data to be a false alarm. A particular implementation may include determining a false event at a sensor hub module and communicating the determination to an operating system input service module. In another example, the host integrated circuit 308 may recognize that the touch event data is associated with a false alarm by looking at learned or contextual information. For example, the system 300 may recognize that stylus contact is irregular and inconsistent. In another example, the system may receive an indication of a display service time out that that is indicative of user input inactivity.

The host circuit 308 may send filtered touch event data to an operating system of the panel display circuit 306 over a channel 358. The panel display circuit 306 may perform system tasks for a handheld device that relate to input/output (I/O), memory, processing, resource management, and security processes.

The touch sensor circuit 304 may communicate the potential touch event data to the panel display circuit 306 over the pin 312 (or other channel), as well as to the host circuit 308 over channel 310. The host circuit 308 may control, among other presentation operations, the frame rate. That is, the host circuit 308 may allocate the FPS to the 302 to boost the frame rate out of idle and into a higher frame rate.

According to an implementation, the panel display circuit 306 may request the higher frame rate from the host circuit 308 after receiving the notifying signal 328 from the touch sensor circuit 304. In such a scenario, the panel display circuit 306 may switch from the slower frame rate to the higher frame rate prior to receiving a filtered signal over channel 360 from the host circuit 308. The filtered signal may indicate whether the touch event was valid or a false alarm based on analysis performed at the host circuit 308.

In the case of where the touch event is determined by the host circuit 308 to be a false alarm, the panel display circuit 306 may switch the higher frame rate at the back to the lower frame rate. Where the filtered signal alternatively confirms that the touch event data is legitimate (i.e., not a false alarm), then the high frame rate that was preemptively provided may be maintained. That is, the high frame rate will not be switched back to idle or some slower frame rate. In this manner, the viewing experience of the user is not marred by pausing and glitches associated with convention boost delays.

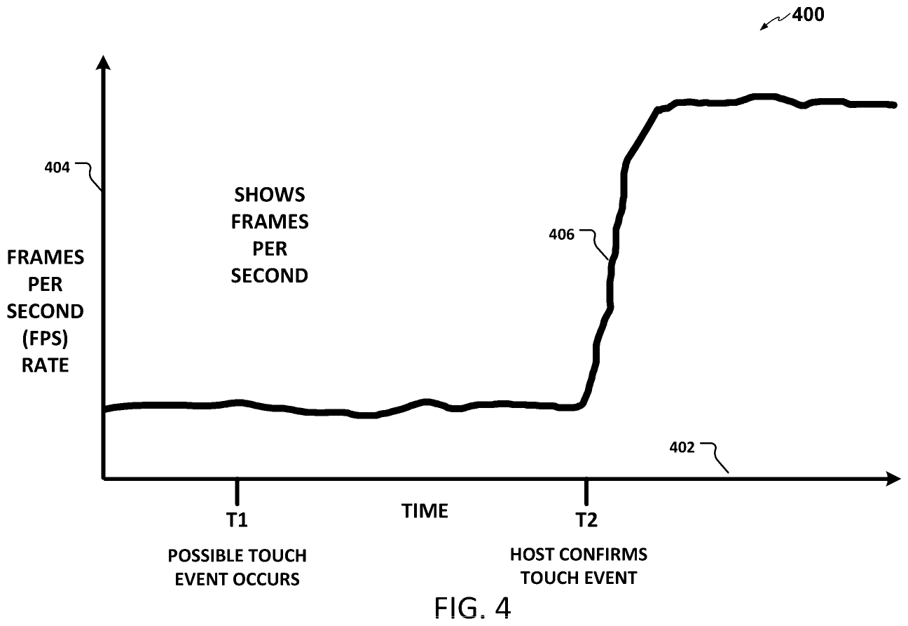

FIG. 4 is a graph 400 that plots a frame rate (e.g., measured in FPS) supplied to a display module versus touch event timing information. In the scenario of FIG. 4, the touch event data is sent only to the host processing unit to be processed through the hardware stages and software stacks of the graphics processing pipeline. For instance, the x-axis 402 of the graph 400 may plot the timing associated with touch data registered by the system 200 of FIG. 2 when the touch panel 206 communicates the touch data via connection 234 to the display driver 240 of the host processing unit 202. The graph 400 does not reflect a scenario where the touch event information is concurrently supplied to a display processor, such as the display processor 204 of FIG. 2 (e.g., via connection 238). As such, the touch event information is evaluated at the host processing unit prior to boosting the FPS to a high frame rate from idle state.

Turning more particularly to the graph 400, a display panel circuit of the system may be operating in an idle state at time T0. At time T1, a host processing unit may receive a signal indicating a potential touch event has been received at a touch sensor. For example, the touch panel 206 of FIG. 2 may communicate the touch data via connection 234 to the display driver 240 of the host processing unit 202. As illustrated in the plotted data 406, the frame rate remains steady (e.g., at an idle state) for a period between the potential touch event at time T1 and time T2, when the host processing unit confirms that the touch event was intentional and otherwise valid. Only after the confirmation will the host processing unit cause the display processor, such as the display processor 204 of FIG. 2, to increase the frame rate at time T2. The increased FPS enable the display client to comfortably display presentation data.

The period between T1 and T2 thus represents the time spent processing touch sensor event information through the graphics processing pipeline of the host. This allocation of time may result in a boosting delay at the display panel. The boosting delay may result in perceptible content glitches and interruptions that detract from a viewing experience until time T2.

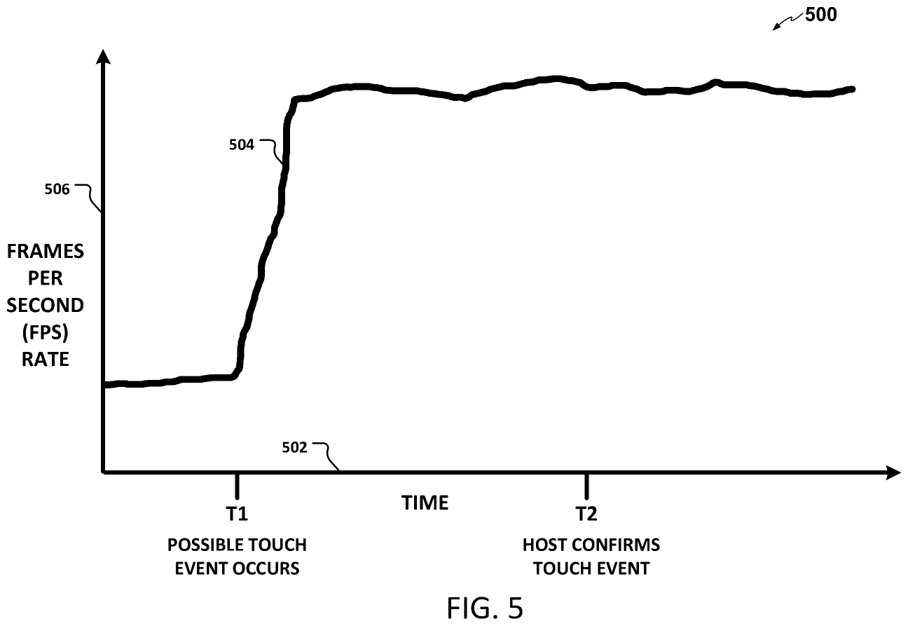

Similar to the graph 400 depicted in FIG. 4, FIG. 5 is a graph 500 that plots a frame rate (e.g., measured in FPS) supplied to a display screen versus touch event timing information. Unlike the scenario of FIG. 4, a frame rate supplied to the display screen may be communicated directly from a touch sensor (e.g., in addition to the host device). For example, x-axis 502 of the graph 500 may plot the touch data 326 of FIG. 2 as delivered to the panel display circuit 306 from the touch sensor circuit 304 via the hardware pin 312. In terms of the illustrative system 200 of FIG. 2, the touch panel 206 communicates the touch data via connection 238 to the display processor 204. The touch data may concurrently be delivered via connection 234 to the display driver 240 of the host processing unit 202. Unlike the scenario in FIG. 4, FIG. 5 shows the timing and associated frame rates for a presentation cycle that involves immediately boosting the frame rate in response to what is subsequently determined by the host device to be a valid touch sensor event.

As shown in the plot 504, the system may make a higher frame rate (e.g., measured in FPS) immediately available (e.g., at time T1) to a display panel. The higher frame r pending subsequent analysis at the host at time T2. In the scenario of FIG. 5, the system may boost the frame rate at T1 in response to a potential touch event. In the case of FIG. 5, the potential touch event is eventually determined to be an actual touch sensor event. That is, a user intentionally touched the touch sensor to initiate a graphics or video display.

Turning more particularly to the graph 500, a display panel circuit of the system may be operating in an idle state at time TO. At time T1, the display panel circuit may receive a signal indicating a potential touch event has been received at the touch sensor. The signal may be received over a dedicated hardware pin connecting the touch sensor to the display panel. In response, the display panel circuit may request an increase to the frame rate from the host at time T2. For example, the display client 208 may request an FPS boost from the display processor 204 of FIG. 2.

At time T1, the display client may boost the frame rate up to a level that may effectively display presentation data without glitches. In this manner, the system may front or advance the higher frame rate in response to a direct signal from a touch sensor indicating a potential touch event. In such a scenario, the system may switch from the slower frame rate to the higher frame rate prior to receiving a filtered signal that indicates whether the touch event was valid or a false alarm. The system is thus immediately ready to provide frequency of frames that may be required in the case of an actual touch event. Put another way, the user may thus enjoy the higher the FPS to watch graphics presented without conventional boosting delays.

In a case where the touch event data is determined to be valid, the host at time T2 may maintain the higher frame rate at the display panel. That is, when the filtered signal confirms that the touch event data is not a false alarm, the high frame rate that was preemptively provided may be maintained. The high frame rate will not be switched back to idle or some slower frame rate. In this manner, the viewing experience of the user is not interrupted by pausing and glitches associated with conventional boost delays.

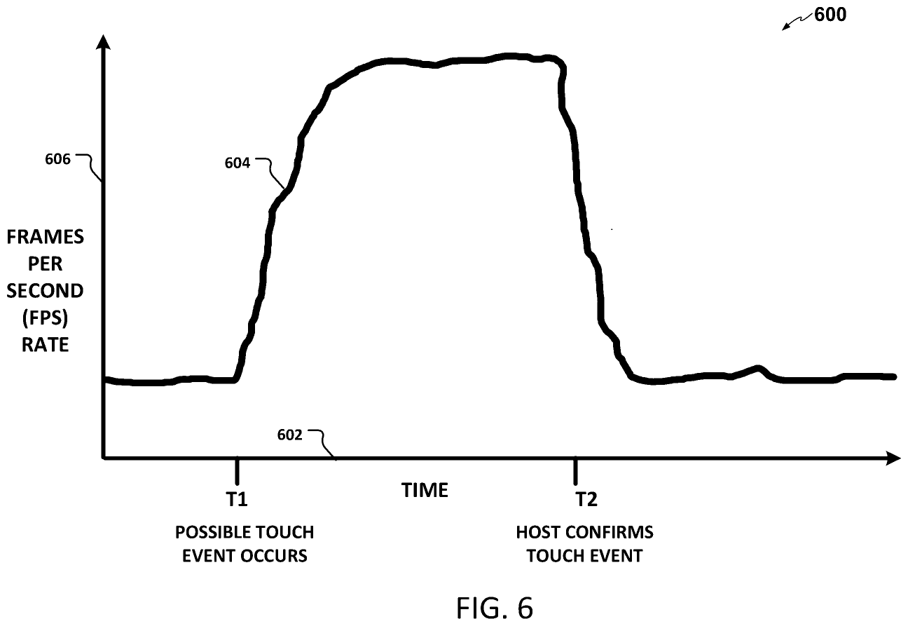

FIG. 6 is a graph 600 that plots a frame rate (e.g., measured in FPS) supplied to a display screen versus touch event timing information. Unlike the scenario of FIG. 5, the system in FIG. 6 may process touch event that is eventually determined to be a false alarm. Such a false alarm may occur when a user unintentionally contacts the touch sensor, or the touch sensor misinterprets inputs from its environment. Similar to the circumstance present at FIG. 5, the frame rate supplied to the display screen may be communicated directly from a touch sensor (e.g., in addition to the host device).

For example, the x-axis 502 of the graph 500 may plot the touch data 326 of FIG. 2 as delivered to the panel display circuit 306 from the touch sensor circuit 304 via the hardware pin 312. In terms of the illustrative system 200 of FIG. 2, the touch panel 206 communicates the touch data via connection 238 to the display processor 204. The touch data may concurrently be delivered via connection 234 to the display driver 240 of the host processing unit 202.

Like the scenario in FIG. 5, FIG. 6 shows the timing and associated frame rates for a presentation cycle that involves immediately boosting frame in response to a potential touch event. However, the FPS is returned to an idle state in response to what is subsequently determined by the host device to be an invalid touch sensor event.

As shown in the plot 604, the system may make a higher frame rate immediately available at time TI to a display panel. In the scenario of FIG. 6, the system may boost the frame rate at TI in response to a potential touch event. In the case of FIG. 6, the potential touch event is eventually determined to be false alarm. That is, a user may not have intended to contact the touch sensor to initiate a graphics or video display.

Turning more particularly to the graph 600, a display panel circuit of the system may be operating in an idle state at time TO. At time T1, the display panel circuit may receive a signal indicating a potential touch event has been received at the touch sensor. The signal may be received over a dedicated hardware pin connecting the touch sensor to the display panel. In response, the display panel circuit may request an increase to the frame rate from the host at time T2. For example, the display client 208 may request an FPS boost from the display processor 204 of FIG. 2.

At time T1, the system may front or advance the higher frame rate in response to a direct signal from a touch sensor indicating a potential touch event. In such an example, the system may switch from the slower frame rate to the higher frame rate prior to receiving a filtered signal that indicates whether the touch event was invalid, or a false alarm. The system is thus immediately ready to provide frequency of frames that would be required in the case of an actual touch event.

In a case where the touch event data is determined to be invalid, the host at time T2 may lower the frame rate at the display panel. That is, when the filtered signal confirms from the host confirms that the touch event data is a false alarm, the high frame rate that was preemptively provided may be switched back to idle or some slower frame rate.

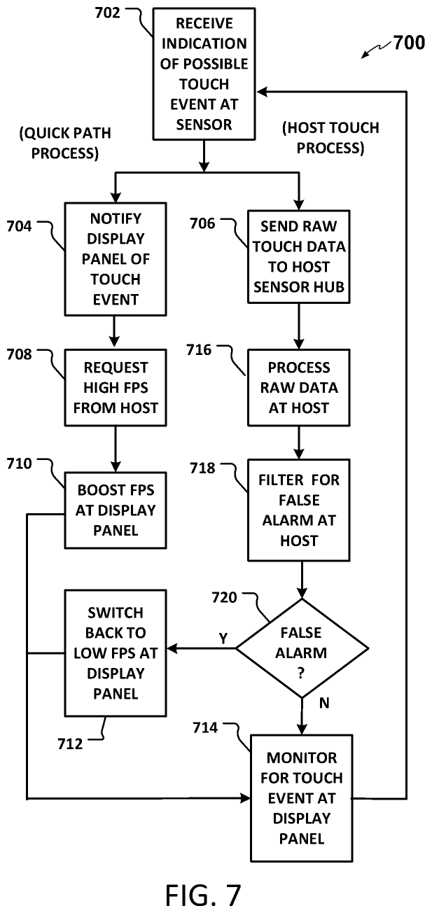

FIG. 7 is a flowchart of an embodiment of a method 700 of managing frame rates when displaying video data to a user. The method 700 may be performed by any of the preceding systems 100, 200, and 300 shown in FIGS. 1-3. In a particular example, method 700 includes communicating touch event information directly from a touch sensor to a display panel module (e.g., a quick path process). In so doing, the system may make a higher frame rate immediately available to a display panel, pending thorough analysis at the host. This process may allow the system to advance the higher frame rate in response to a direct signal from a touch sensor indicating a potential touch event. A host path process of the method may verify whether the potential touch event is legitimate or a false alarm. In this manner, the method 700 may avoid interrupting a viewing experience of a user with pauses and glitches associated with conventional boost delays.

Turning more particularly to the flowchart, a touch event sensor may receive at 702 an indication of a possible touch event. For example, the touch sensor circuit 304 of FIG. 3 may receive an indication of potential touch event(s) 320.

The touch event sensor may notify the display panel at 704 of the potential touch event. The notification at 704 may be communicated directly to the display panel without first being verified by stages of a host. In terms of the illustrative system 200 of FIG. 2, the touch panel 206 may communicate the touch data via connection 238 to the display processor 204. As is described in further detail herein, the touch data may concurrently be delivered at 706 via connection 234 to the display driver 240 of the host processing unit 202.

In response to receiving the notification at 704, the display panel at 708 may request a higher frame rate from the host. Continuing with the example of FIG. 2, the display processor 204 may request an FPS boost from the display processor 204. Prior to the request at 708, the display panel may have been operating in an idle state to conserve processing power. The display panel may request the higher frame rate against the possibility of the sensor touch event being legitimate. In this manner, the display panel may have its FPS immediately increased to a level that avoids a perceptible interruption or glitch.

At 710, the host may provide the requested higher frame rate to the display panel. For example, the processing unit 202 of the host unit may cause the display processor 204 to provide a higher FPS to the display client 208. The resultant boost at 710 may avoid potential degradation of the presentation of data at the handheld device of the user. In this manner, the left-hand side of the flowchart (i.e., 702 704, 708, and 710) illustrates what may be characterized as a quick path towards frame rate boosting at the display panel.

The panel display may then continue to operate at the higher frame until normal operation of the panel display initiates otherwise or the method 700 switches back to a lower FPS at 712. In either case, the method 700 at 714 may then continue to monitor for potential touch events.

The switch back operation at 712 may function as a culmination of one outcome of a touch event verification process illustrated by the right-hand, host touch process side of the flowchart (i.e., 706, 716, 718, and 720). More particularly, the touch sensor at 708 may send raw touch data to a sensor hub in response to a potential touch event at 702. In terms of FIG. 2, the touch data may concurrently be delivered via connection 234 to the display driver 240 of the host processing unit 202.

At 716, the raw data may be processed at the host. For example, the processor 340 of the host circuit 308 of FIG. 3 may execute a graphics processing pipeline 327 that includes one or more processing stages that operate together to execute graphics processing commands and to output a frame to the panel display circuit 306.

The host device at 718 may filter the processed touch data to determine if the potential touch event data that was initially presented at 702 is actually a false alarm. Should the filtering process at 712 may determine that the potential touch event is a false alarm, then the host at 712 may switch back the FPS at the display panel to that of its prior, slower frame rate. That is, when the filtered signal confirms from the host confirms that the touch event data is a false alarm, the high frame rate that was preemptively provided at 710 may be switched back to idle or some slower frame rate at 712.

Should the potential touch event alternatively be determined at 720 to be an actual touch event, then the method 700 may continue to provide the higher frame rate to the display panel at 714 while it monitors for additional potential touch events.

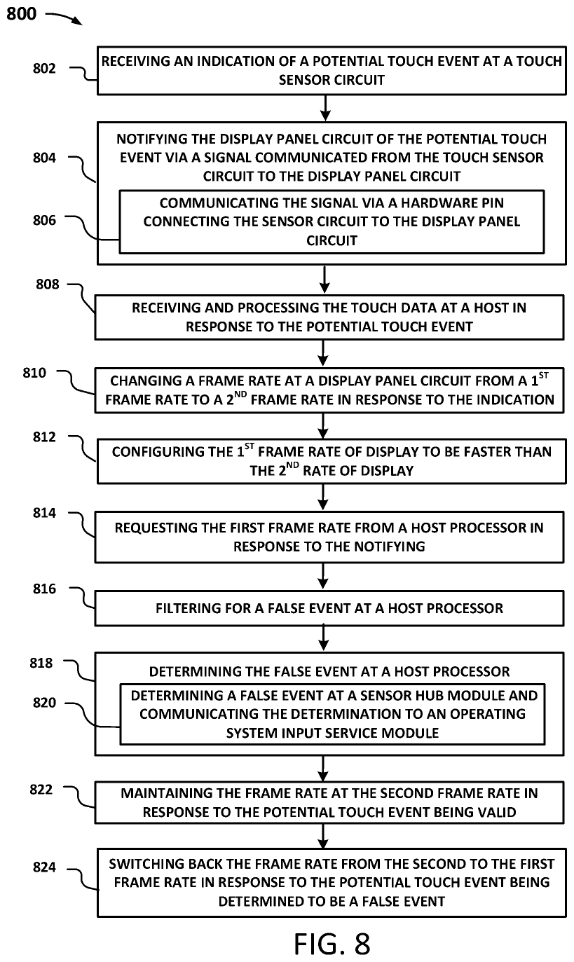

FIG. 8 is an illustrative implementation of a method 800 of display processing. The method 800 may be performed by any of the preceding systems 100, 200, and 300 shown in FIGS. 1-3. In a particular example, method 800 includes receiving at 802 an indication of a potential touch event at a touch sensor circuit. For example, the touch sensor circuit 304 of FIG. 3 may receive an indication of potential touch events 320 from a user.

At 804, the method 800 may include notifying the display panel circuit of the potential touch event via a signal communicated from the touch sensor circuit to the display panel circuit. In terms of the illustrative system 200 of FIG. 2, the touch panel 206 may communicate the touch data via connection 238 to the display processor 204. As shown at 806, the notification may include communicating the signal via a hardware pin connecting the sensor circuit to the display panel circuit. For instance, the connection 238 of FIG. 2 connects the touch panel to the display processor 204. As is described in further detail herein, the touch data may at 808 additionally be delivered via connection 234 to the display driver 240 of the host processing unit 202.

At 810, an implementation of the method 800 may include changing a frame rate at the display panel circuit from a first frame rate to a second frame rate in response to the indication of the potential touch event. As represented at 812, the first frame rate may comprise a slower FPS (e.g., associated with an idle state) than the second FPS.

For example, the panel display circuit 306 of FIG. 3 may directly request a boosted frame rate from the host circuit 308 at 814 of FIG. 8 in response to the notification.

The method 800 at 816 may include filtering for a false event at a host processor. Determining a false event at 818 may be performed at a sensor hub module at 820 and may include communicating the determination to an operating system input service module.

Where the notification is not a false alarm, the method 800 at 822 may include maintaining the frame rate at the second frame rate in response to the potential touch event. For example, the FPS plot 504 of FIG. 5 is maintained at time T2 when the host device validates the touch event.

Where the notification is not a false alarm, the method 800 at 824 may include further include switching back the frame rate from the second to the first frame rate in response to the potential touch event being determined to be a false event. For example, the FPS plot 604 of FIG. 6 may revert back to the idle state at time T2 when the host device invalidates the touch event.

Implementation examples are described in the following numbered clauses:
1. A method of display processing, the method comprising:
receiving an indication of a potential touch event at a touch sensor circuit;
notifying a display panel circuit of the potential touch event via a signal communicated from the touch sensor circuit to the display panel circuit; and
changing a frame rate at the display panel circuit from a first frame rate to a second frame rate in response to the indication.
2. The method of clause 1, further comprising switching back the frame rate from the second to the first frame rate in response to the potential touch event being determined to be a false event.
3. The method of clauses 1 or 2, further comprising maintaining the frame rate at the second frame rate in response to the potential touch event being determined to be valid.
4. The method of clauses 1-3, further comprising communicating the signal via a hardware pin connecting the sensor circuit to the display panel circuit.
5. The method of clauses 1-4, further comprising requesting the first frame rate from a host processor in response to the notifying.
6. The method of clauses 1-5, further comprising determining a false event at a host processor.
7. The method of clauses 1-6, further comprising configuring the first frame rate of display to be faster than the second frame rate of display.
8. The method of clauses 1-7, further comprising filtering for a false event at a host processor.

9. The method of clauses 1-8, further comprising monitoring for the touch event at the display panel circuit.
10. The method of clauses 1-9, further comprising communicating raw touch data to a host processor in response to the potential touch event.
11. The method of clauses 1-10, further comprising determining a false event in response to a timeout function based on a time the raw touch data was communicated.
12. The method of clauses 1-11, further comprising determining a false event at a sensor hub module and communicating the determination to an operating system input service module.
13. The method of clauses 1-12, further comprising processing the raw touch data at the host processor.
14. An apparatus comprising:
a touch sensor circuit to sense user physical contact comprising a touch event;
a display panel circuit to render graphical data for display;
a memory; and
one or more processors communicatively coupled with the memory, the display panel circuit, and the touch sensor circuit, the one or more processors configured to:
   receive an indication of a potential touch event at the touch sensor circuit;
   notify the display panel circuit of the potential touch event via a signal communicated from the touch sensor circuit to the display panel circuit; and
   change a frame rate at the display panel circuit from a first frame rate to a second frame rate in response to the indication.
15. The apparatus of clause 14, wherein the frame rate is switched from the second to the first frame rate in response to the potential touch event being determined to be a false event.
16. The apparatus of clause 14 or 15, wherein the frame rate is maintained at the second frame rate in response to the potential touch event being determined to be valid.
17. The apparatus of clauses 14-16, further comprising a hardware pin connecting the sensor circuit to the display panel circuit, wherein the hardware pin communicates the signal.
18. The apparatus of clauses 14-17, further comprising a host device configured to execute the one or more processors to receive a request for the first frame rate.
19. The apparatus of clauses 14-18, further comprising a host device configured to execute the one or more processors to determine a false event.
20. The apparatus of clauses 14-19, wherein the first frame rate of display is faster than the second frame rate of display.
21. The apparatus of clauses 14-20, further comprising a host device configured to execute the one or more processors to filter for a false event.
22. The apparatus of clauses 14-21, wherein the display panel circuit monitors for the touch event.
23. The apparatus of clauses 14-22, further comprising a host device configured to execute the one or more processors to receive raw touch data in response to the potential touch event.
24. The apparatus of clauses 14-13, wherein the false event is determined in response to a timeout function based on a time the raw touch data was communicated.
25. The apparatus of clauses 14-24, further comprising a host device configured to execute the one or more processors to evaluate the raw touch data at the host processor.
26. A graphics processing device comprising:
a means for receiving an indication of a potential touch event at a touch sensor circuit;
a means for notifying a display panel circuit of the potential touch event via a signal communicated from the touch sensor circuit to the display panel circuit; and
a means for changing a frame rate at the display panel circuit from a first frame rate to a second frame rate in response to the indication.
27. The graphics processing device of clause 26, further comprising a means for switching back the frame rate from the second to the first frame rate in response to the potential touch event being determined to be a false event.
28. The graphics processing device of clause 26 or 27, further comprising a means for communicating the signal via a hardware pin connecting the sensor circuit to the display panel circuit.
29. A computer-readable medium storing computer executable code for graphics processing, the computer executable code being configured to:
receive an indication of a potential touch event at a touch sensor circuit;
notify a display panel circuit of the potential touch event via a signal communicated from the touch sensor circuit to the display panel circuit; and
change a frame rate at the display panel circuit from a first frame rate to a second frame rate in response to the indication.
30. The computer-readable medium of clause 29, the computer executable code is further configured to maintain the frame rate at the second frame rate in response to the potential touch event being determined to be valid

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c. As used herein, “based on” is intended to be interpreted in the inclusive sense, unless otherwise explicitly indicated. For example, “based on” may be used interchangeably with “based at least in part on,” unless otherwise explicitly indicated. Specifically, unless a phrase refers to “based on only ‘a,”’ or the equivalent in context, whatever it is that is “based on 'a,”“ or ”based at least in part on 'a,“ may be based on ”a“ alone or based on a combination of “a” and one or more other factors, conditions, or information.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also may be implemented in combination in a single implementation. Conversely, various features that are described in the context of a single implementation also may be implemented in multiple implementations separately or in any suitable sub combination. As such, although features may be described above as acting in particular combinations, and even initially claimed as such, one or more features from a claimed combination may in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted may be incorporated in the example processes that are schematically illustrated. For example, one or more additional operations may be performed before, after, simultaneously, or between any of the illustrated operations. In some circumstances, multitasking and parallel processing may be advantageous.

Moreover, the separation of various system components in the implementations described above should not be understood as requiring such separation in all implementations, and it should be understood that the described program components and systems may generally be integrated together in a single software product or packaged into multiple software products.

1. A method of display processing, the method comprising:
receiving an indication of a potential touch event at a touch sensor circuit;
notifying a display panel circuit of the potential touch event via a signal communicated from the touch sensor circuit to the display panel circuit; and
changing a frame rate at the display panel circuit from a first frame rate to a second frame rate in response to the indication.

2. The method of claim 1, further comprising switching back the frame rate from the second to the first frame rate in response to the potential touch event being determined to be a false event.

3. The method of claim 1, further comprising maintaining the frame rate at the second frame rate in response to the potential touch event being determined to be valid.

4. The method of claim 1, further comprising communicating the signal via a hardware pin connecting the sensor circuit to the display panel circuit.

5. The method of claim 1, further comprising requesting the first frame rate from a host processor in response to the notifying.

6. (canceled)

7. The method of claim 1, further comprising configuring the first frame rate of display to be faster than the second frame rate of display.

8. (canceled)

9. The method of claim 1, further comprising monitoring for the touch event at the display panel circuit.

10. The method of claim 1, further comprising communicating raw touch data to a host processor in response to the potential touch event.

11. (canceled)

12. (canceled)

13. (canceled)

14. An apparatus comprising:
a touch sensor circuit to sense user physical contact comprising a touch event;
a display panel circuit to render graphical data for display;
a memory; and
one or more processors communicatively coupled with the memory, the display panel circuit, and the touch sensor circuit, the one or more processors configured to:
receive an indication of a potential touch event at the touch sensor circuit;
notify the display panel circuit of the potential touch event via a signal communicated from the touch sensor circuit to the display panel circuit; and
change a frame rate at the display panel circuit from a first frame rate to a second frame rate in response to the indication.

15. The apparatus of claim 14, wherein the frame rate is switched from the second to the first frame rate in response to the potential touch event being determined to be a false event.

16. The apparatus of claim 14, wherein the frame rate is maintained at the second frame rate in response to the potential touch event being determined to be valid.

17. The apparatus of claim 14, further comprising a hardware pin connecting the sensor circuit to the display panel circuit, wherein the hardware pin communicates the signal.

18. The apparatus of claim 14, further comprising a host device configured to execute the one or more processors to receive a request for the first frame rate.

19. The apparatus of claim 14, further comprising a host device configured to execute the one or more processors to determine a false event.

20. The apparatus of claim 1, wherein the first frame rate of display is faster than the second frame rate of display.

21. The apparatus of claim 1, further comprising a host device configured to execute the one or more processors to filter for a false event.

22. The apparatus of claim 1, wherein the display panel circuit monitors for the touch event.

23. The apparatus of claim 1, further comprising a host device configured to execute the one or more processors to receive raw touch data in response to the potential touch event.

24. The apparatus of claim 23, wherein a false event is determined in response to a timeout function based on a time the raw touch data was communicated.

25. The apparatus of claim 23, further comprising a host device configured to execute the one or more processors to evaluate the raw touch data.

26-30. (canceled)
